(19) United States
(12) Patent Application Publication
(10) Pub. No.: US 2006/0095505 A1
(43) Pub. Date: May 4, 2006

(54) Providing a trustworthy configuration server

(76) Inventors: Vincent J. Zimmer, Federal Way, WA (US); Michael A. Rothman, Puyallup, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/955,574

(22) Filed: Sep. 30, 2004

(51) Int. Cl. G06F 15/16

(52) U.S. Cl. 709/203

(57) ABSTRACT

A method and article of manufacture to provide a trustworthy configuration server. A connection between a server and a client is established during a preboot of the client. Server integrity of the server is verified by the client during the preboot of the client. The client is booted with a boot image file received from the server if the server integrity is verified. The client disengages from server if the server integrity is not verified.

### BACKGROUND

1. Field

Embodiments of the invention relate to the field of computer systems and more specifically, but not exclusively, to providing a trustworthy configuration server.

2. Background Information

Various schemes may be used to provide security protection for a network. Common security measures include firewalls, virus scanners, and encryption software. Industry leaders have organized a Trusted Computing Group (TCG) to address security issues. TCG is an industry standards body, including computer manufacturers, device manufacturers, and software vendors, who are promoting the security of computing platforms and devices (see, https://www.trustedcomputinggroup.org).

One goal of TCG is to promote a security hardware device called the Trusted Platform Module (TPM). The TPM is an isolated device attached to the motherboard of a computer system for establishing trust and trust metrics in a trusted computing environment.

In today's client/server environment, a client may not be assured of the integrity of a server system.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating one embodiment of an environment to support providing a trustworthy configuration server in accordance with the teachings of the present invention.

FIG. 2 is a flowchart illustrating one embodiment of the logic and operations to provide a trustworthy configuration server in accordance with the teachings of the present invention.

FIG. 3 is a block diagram illustrating one embodiment of an environment to support providing a trustworthy configuration server in accordance with the teachings of the present invention

FIG. 4 is a block diagram illustrating one embodiment of a trusted platform module in accordance with the teachings of the present invention

FIG. 5A is a block diagram illustrating one embodiment of a client in accordance with the teachings of the present invention

FIG. 5B is a block diagram illustrating one embodiment of a client in accordance with the teachings of the present invention

FIG. 6 is a flowchart illustrating one embodiment of the logic and operations to provide a trustworthy configuration server in accordance with the teachings of the present invention.

FIG. 7 is a flowchart illustrating one embodiment of the logic and operations to provide a trustworthy configuration server in accordance with the teachings of the present invention.

FIG. 8 is a flowchart illustrating one embodiment of the logic and operations to provide a trustworthy configuration server in accordance with the teachings of the present invention.

FIG. 9 is a flowchart illustrating one embodiment of the logic and operations to provide a trustworthy configuration server in accordance with the teachings of the present invention.

FIG. 10 is a block diagram illustrating one embodiment of a computer system to implement embodiments of the present invention.

### DETAILED DESCRIPTION

In the following description, numerous specific details are set forth to provide a thorough understanding of embodiments of the invention. One skilled in the relevant art will recognize, however, that embodiments of the invention can be practiced without one or more of the specific details, or with other methods, components, materials, etc. In other instances, well-known structures, materials, or operations are not shown or described in detail to avoid obscuring understanding of this description.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

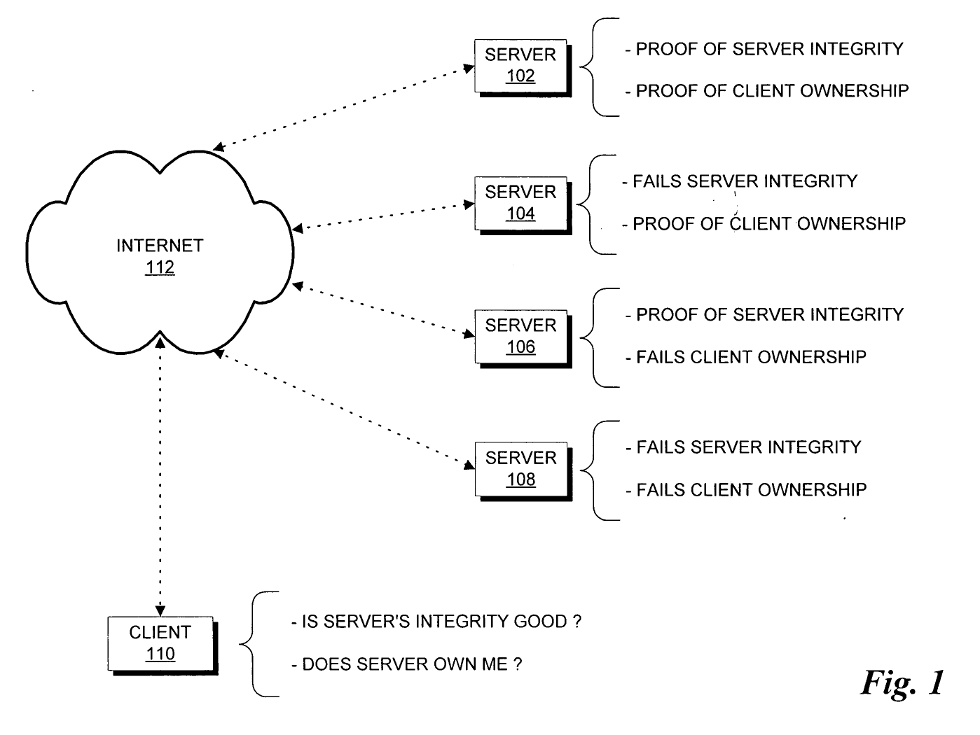

Referring to FIG. 1, one embodiment of a client/server environment is shown. Client 110 is connected to internet 112. Server 102, 104, 106, and 108 are each connected to internet 112. Client 110 and servers 102-108 may be coupled by wired connections, wireless connections, or any combination thereof. Internet 112 may include a group of networks connected by routing devices that pass network traffic between computers attached to the networks of the group of networks. In one embodiment, internet 112 includes the global “Internet.”

In one embodiment, client 110 connects to internet 112 during the client's preboot to find a boot image file from a server. Preboot includes the period of time between system reset and execution of an operating system on client 110. Operating system (OS) runtime begins when the OS takes control of the client 110. In one embodiment, the boot image file includes an operating system.

Embodiments of the present invention provide for the client to verify the integrity of the server before receiving a boot image file from the server. Embodiments described herein also allow the client to determine if the client is “owned” by the server prior to receiving the boot image file. In one embodiment, a server owns a client when the server and the client are part of the same enterprise. In one embodiment, a client may be owned by more than one enterprise (discussed further below).

Embodiments described herein provide for security verification between a client and server across an open enterprise. In embodiments where the server and client communicate across the Internet and not in a closed network, trusted verification of the identity of client and server is vital. The client may be assured that the server is in a known, validated state before receiving a boot image file from the server. This prevents a compromised server from installing an errant boot image file on the client.

In one embodiment, client 110 may include a computer system that is part of an enterprise. An enterprise includes one or more networks that connect various devices owned by a particular entity. Such entities may include corporations, non-profit groups, or other organizations. Private connections, leased lines, or public connections may interconnect these networks. Routers, bridges, or the like may make connections between networks. The entity's computers, voice, video, and data resources may be connected to the various networks.

Client 110 connects to internet 112 and requests a communication protocol from a server. In one embodiment, client 110 may make a Dynamic Host Configuration Protocol (DHCP) request on internet 112. When a server responds to the client's request, client 110 may take actions to determine the trustworthiness of the server and to determine whether the client is owned by the server.

FIG. 1 shows various scenarios in response to client 110's inquiries. Server 102 may show proof of integrity and proof of ownership. Server 104 fails for integrity, but may show proof of ownership. For example, server 104's integrity may have been compromised by a virus on the server.

Server 106 may show proof of server integrity, but fails for proof of ownership. In one embodiment, since server 106 does not have ownership, server 106 is not permitted to load a boot image file onto client 110. In another embodiment, server 106 is allowed to take ownership of client 110 in the field. Server 108 fails for server integrity and for client ownership.

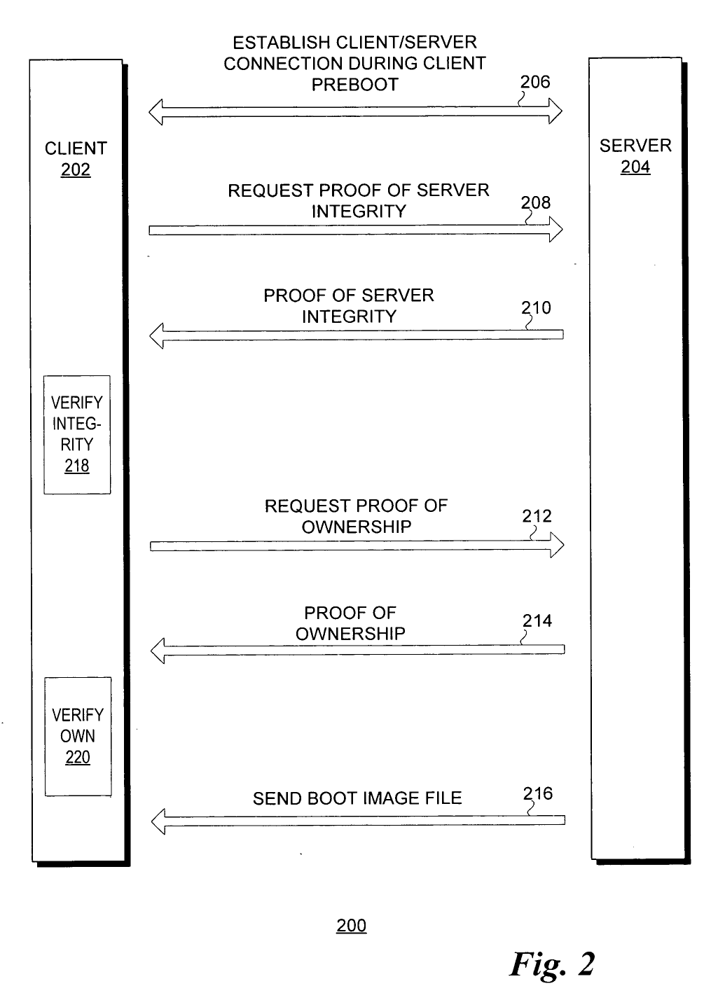

Turning to FIG. 2, a flowchart 200 illustrates the logic and operations to provide a trustworthy configuration server in accordance with one embodiment of the present invention. Flowchart 200 shows the communications and transactions between a client 202 and a server 204. Starting at flow 206, a connection is established between client 202 and server 204 during preboot of client 202.

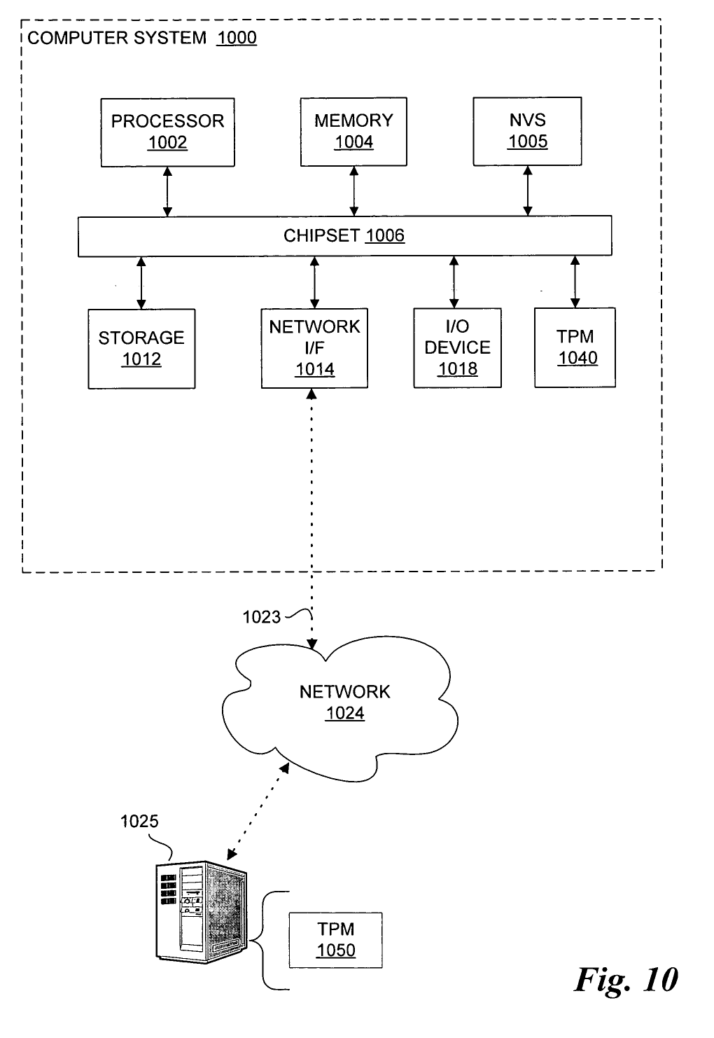

In one embodiment, firmware instructions to support embodiments as described herein are stored in a non-volatile storage device of client 202. These firmware instructions operate at least during the preboot of client 202. Embodiments of non-volatile storage devices are discussed below in conjunction with FIG. 10.

In one embodiment, the preboot environment of client 202 may operate in accordance with an Extensible Firmware Interface (EFI) (Extensible Firmware Interface Specification, Version 1.10, Dec. 1, 2002, available at http://developer.intel.com/technology/efi.) EFI enables firmware, in the form of firmware modules and drivers, to be loaded from a variety of different resources, including Flash memory devices, option ROMs (Read-Only Memory), other storage devices, such as hard disks, CD-ROM (Compact Disk-Read Only Memory), or from one or more computer systems over a computer network. One embodiment of an implementation of the EFI specification is described in the Intel® Platform Innovation Framework for EFI Architecture Specification-Draft for Review, Version 0.9, Sep. 16, 2003 (available at www.intel.com/technology/framework). It will be understood that embodiments of the present invention are not limited to the “Framework” or implementations in compliance with the EFI specification.

In one embodiment, the connection is established using the Dynamic Host Configuration Protocol (DHCP). DHCP allows a computer to join a network and obtain an Internet Protocol (IP) address. In short, client 202 broadcasts a request for an IP address assignment. A server, such as server 204, replies with an IP address assigned to client 202. DHCP is well known to one skilled in the art.

In one embodiment, server 204 provides for remote booting using a Preboot Execution Environment (PXE) (see Preboot Execution Environment Specification, version 2.1, Sep. 20, 1999). PXE is part of the Wired for Management (WfM) industry standard (see Wired for Management Baseline, version 2.0, Dec. 18, 1998). In short, WfM provides preboot management, power management, and information management of computer systems. PXE provides for a boot image file, such as an OS, to be loaded over a network connection. In one embodiment, the client's Network Interface Card (NIC) may be configured as a standard boot device, such as commonly is done with a hard disk drive.

In one embodiment, the PXE client makes a DHCP discovery request during the preboot of the PXE client. The DHCP discovery request includes a tag identifying the client as a PXE client. When a PXE server sees the tag, the PXE server replies to the PXE client with configuration information, including the name of the boot image file. The boot image file may be transferred to the PXE client using the Trivial File Transfer Protocol (TFTP). The received boot image file is used to boot the client.

Continuing in FIG. 2, at flow 208, client 202 requests proof of server integrity from server 204. In flow 210, server 204 sends proof of its integrity to client 202. In a block 218, client 218 verifies the integrity of server 204 based on the proof of integrity received from server 204.

Continuing to flow 212, client 202 requests proof of ownership from server 204. In flow 214, server 204 sends proof of ownership to client 202. In a block 220, client 202 verifies the proof of ownership received from server 204. In flow 216, the boot image file is sent from server 204 to client 202 for loading and execution on client 202.

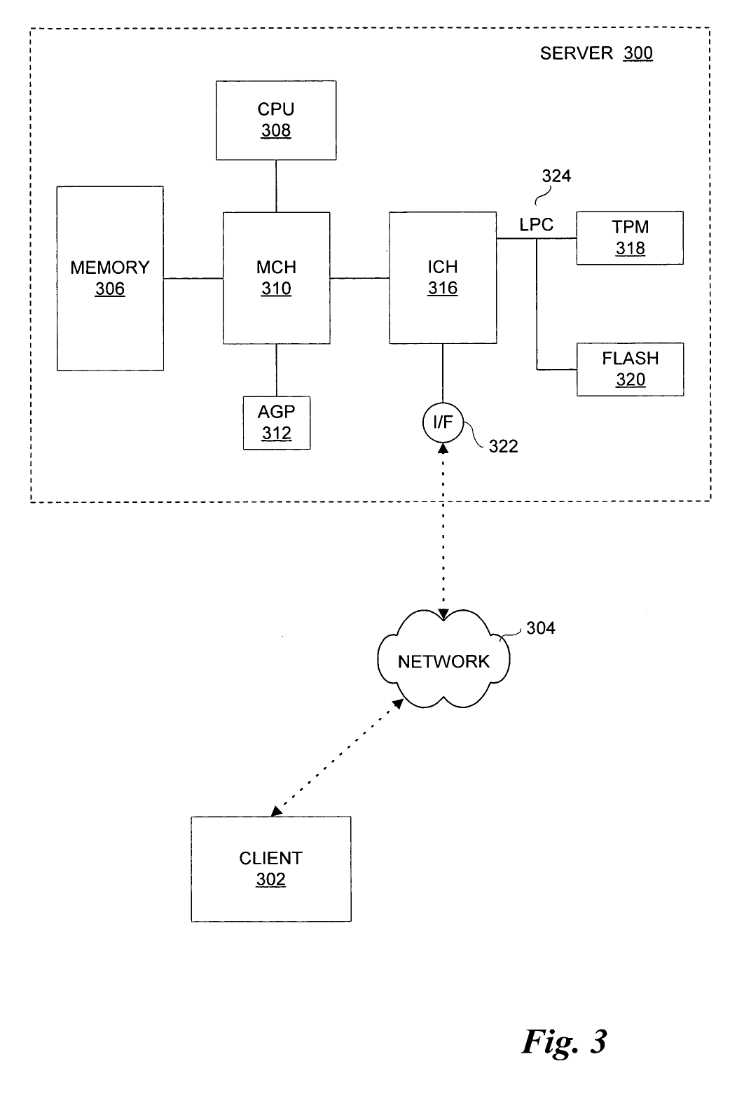

Referring to FIG. 3, an embodiment of a server 300 is shown. Server 300 may be connected to client 302 via network 304. In one embodiment, network 304 includes the Internet.

Server 300 includes a Central Processing Unit (CPU) 308 coupled to Memory Controller Hub (MCH) 310. Memory 306 is coupled to MCH 310. In one embodiment, memory 306 includes Random Access Memory (RAM). Accelerated Graphics Port (AGP) 312 may also be coupled to MCH 310.

ICH 316 may be coupled to MCH 310. Network interface (I/F) 322 may coupled to ICH 316. Network I/F 322 may be used for connecting server 300 to network 304. Flash memory 320 may be coupled to ICH 316. Other types of non-volatile storage, such as Random Access Memory (ROM), may be coupled to ICH 316 in place of or in addition to Flash memory 320. TPM 318 may be coupled to ICH 316 via a Low Pin Count (LPC) bus 324. In one embodiment, server 300 may include LaGrande Technology (LT) (discussed below). Instructions to support embodiments described herein may be stored in memory 306, flash memory 320, or other storage devices of server 300.

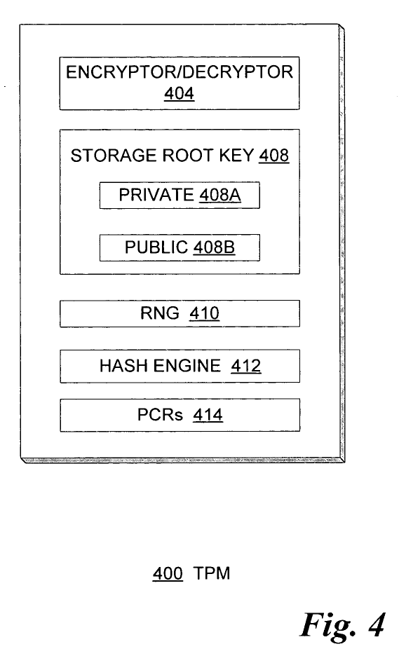

Referring to FIG. 4, an embodiment of a TPM 400 is shown. TPM 400 includes cryptographic functions that may be executed on board the TPM hardware. The TPM is described in the TPM Main Specification, (Parts 1-3), Version 1.2, Oct. 2, 2003. While embodiments herein include a TPM, it will be understood that alternative embodiments may include other types of trusted hardware devices.

TPM 400 may include an encryptor/decryptor 404, a Storage Root Key (SRK) 408, a random number generator (RNG) 410, a hash engine 412, and Platform Configuration Registers (PCRS) 414.

In one embodiment, TPM 400 provides various security functions. TPM 400 may provide sealing and unsealing of secret information. In one embodiment, TPM 400 includes security measures to disable TPM 400 should someone attempt to physically modify or physically remove TPM 400 from a system.

SRK 408 includes a public/private key pair 408A and 408B. Private key 408A never leaves TPM 400. Any information encrypted with public key 408B can only be decrypted by the corresponding private key 408A of TPM 400. A private key is unique to every TPM, so only TPM 400 can decrypt the data encrypted with public key 408B.

Hash values representing platform configuration information may be securely stored in the PCRs 414. The hash values enable verification of the platform configuration. In one embodiment, TPM 400 includes 16 PCRs (PCR[0] to PCR [15]). Standardized assignments of PCRs to particular configuration information are disclosed in the TPM Main Specification.

A hashing function is an algorithm that turns a variable-sized data block into a fixed-sized hash value. Hashing functions are used to encrypt information. Hash engine 412 may support the secure hash algorithm-1 (SHA-1). TPM 400 may also include a hardware engine, such as encryptor/decryptor 404, to perform Rivest-Shamir-Adleman (RSA) encryption and decryption.

TPM 400 may be used to store secret information as a “blob” (Binary Large Object). TPM 400 may be used to create a blob and used to return the content of a blob. Blobs may be used to store secret data such as credit card numbers, social security numbers, passwords, or the like.

Secret information may be tied to a configuration of a platform through the TPM Seal and Unseal commands. Sealing provides assurances that secret information is only recoverable when the platform is functioning in a specific known configuration. Information sealed by a particular platform is only accessible by that platform if the conditions specified in the sealing are met.

For the Unseal operation to succeed, proof of the platform configuration that was in effect when the Seal operation was performed must be provided to the TPM. If the sealing conditions of the blob are not met, access to the secret information in the blob is denied.

The Seal and Unseal operations may be used with the PCRs of the TPM. For example, a Secret may be sealed by a platform TPM using the command. SEAL (Secret, PCR_value) to generate Blob1. PCR_value describes the configuration of the platform when Blob1 was created. Blob1 may be sent to other systems, however, the Secret is securely encrypted in Blob1.

To decrypt the Secret, the platform must be in the same configuration as when the Secret was sealed. The Secret will only by revealed if the Secret was encrypted on the decrypting platform and the current configuration of the platform as defined by PCR_value is the same. If these requirements are met, then UNSEAL (Blob1) will return the Secret to the caller. It will be understood that the operands of the SEAL and UNSEAL examples above have been simplified for the sake of discussion herein.

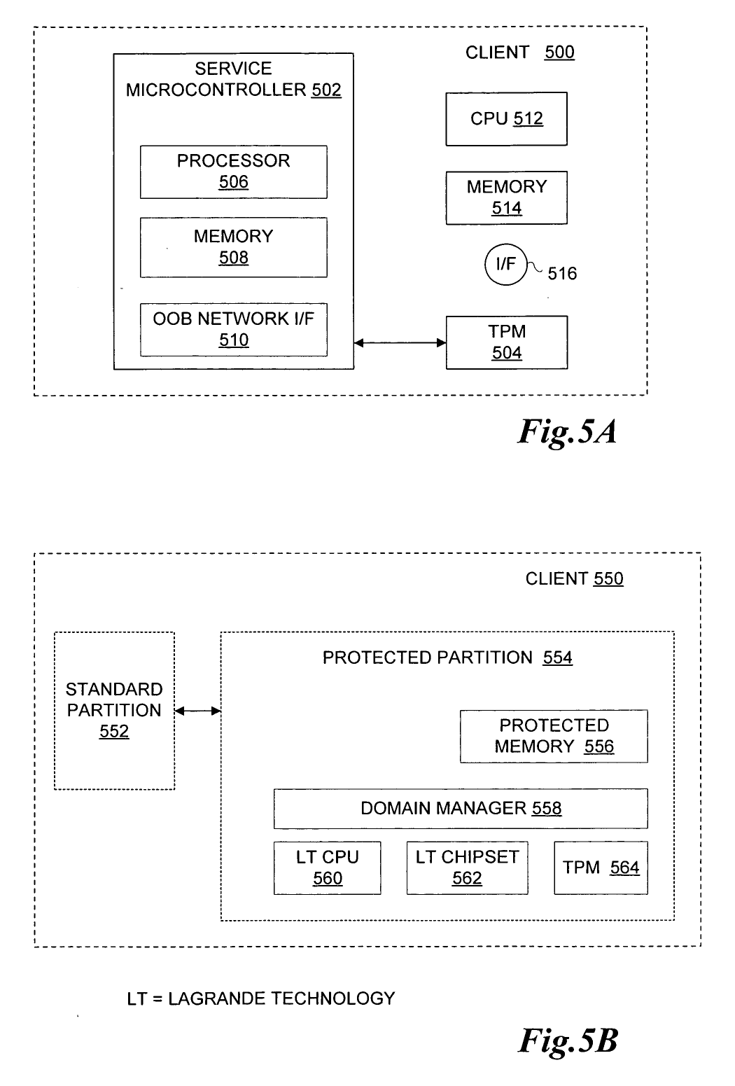

FIGS. 5A and 5B show embodiments of a client. The embodiments of FIGS. 5A and 5B provide protected environments of the client for conducting operations as described herein. Such protected environments may shield essential systems of the client from being inspected or modified by an unauthorized or malicious server.

Referring to FIG. 5A, an embodiment of a client 500 is shown. Client 500 includes a CPU 512, system memory 514, and a network interface (I/F) 516. Client 500 includes a service microcontroller 502 and TPM 504 for isolating operations to verify the integrity and the ownership of a server according to embodiments described herein. Service microcontroller 502 may include a processor 506, memory 508, and an Out-Of-Band (OOB) network I/F 510.

Security operations as described herein may be conducted in service microcontroller 502 to isolate these operations away from CPU 512, memory 514, and network I/F 516. Service microcontroller 502 and TPM 504 provide a tamper proof environment for verifying the integrity and ownership of a server. Communications are routed through OOB network I/F 510 instead of the “normal” network interface 516. An attack from a server may be isolated to service microcontroller 502 to keep such an attack from reaching CPU 512 and memory 514.

Referring to FIG. 5B, an embodiment of a client 550 is shown. Client 550 employs LaGrande Technology (LT). LT includes a set of enhanced hardware components designed to provide security to a computer system. LT may keep sensitive information safe from cyber-attacks.

Client 550 includes an LT CPU 560, an LT chipset 562 and a TPM 564. LT chipset 562 supports protection of memory and input/output devices, as well as providing an interface to TPM 564. Extensions of LT CPU 560 provide for the generation of multiple execution environments. One of these environments includes a standard partition 552, while another environment includes a protected partition 554. The verification of server integrity and ownership, as described herein, may be executed in the protected partition 554 during preboot of client 550.

Standard partition 552 includes an execution environment similar to an Intel Architecture (IA) 32 environment. Standard partition 552 may be used to run operating systems and applications. However, standard partition 552 may not be secure.

Protected partition 554 may be used to run security conscious software that makes use of the features of the LT hardware. Applications may be run in isolation from other applications in the protected partition 554 as well as in isolation from applications in the standard partition 552. Domain manager 558 may provide separation of domains within the protected partition 554. Sensitive instructions and data of client 550 may be placed in protected memory 556 to prevent unauthorized viewing or modification.

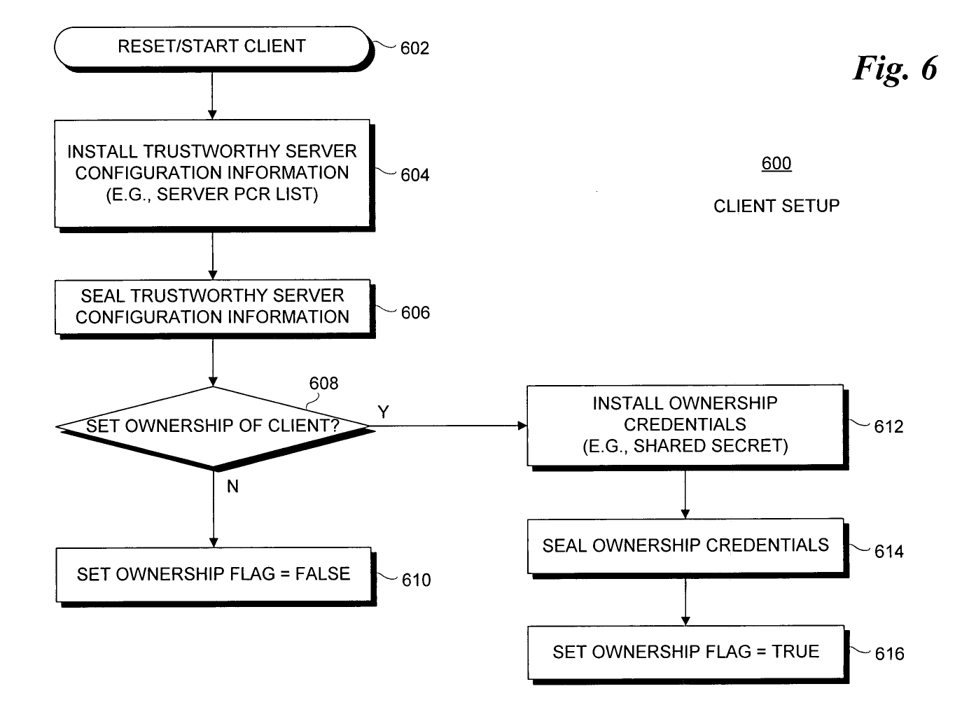

Referring to FIG. 6, a flowchart 600 illustrates the logic and operations to perform a client setup in accordance with one embodiment of the present invention. In one embodiment, the blocks of flowchart 600 may occur at a factory by a system manufacturer. The configuration information and ownership credentials may be installed by the system manufacturer according to a customer order. In another embodiment, the blocks of flowchart 600 may be conducted by the Information Technology (IT) department of a corporation before the client is deployed in the field.

Starting in a block 602, a client is reset/started. Proceeding to a block 604, trustworthy server configuration information is installed on the client. In one embodiment, a PCR list for at least one trustworthy server is installed. Continuing to a block 606, the trustworthy server configuration information is sealed by a TPM of the client. The trustworthy server configuration information is the secret that is sealed against a PCR of the client.

After block 606, the logic proceeds to a decision block 608 to determine if the ownership of the client is to be set. If the answer to decision block 608 is no, then logic proceeds to a block 610 to set an ownership flag of the client to false.

In one embodiment, the client ownership flag is set to false so that the client ownership may be established after the client is deployed in the field. Such a scenario may be described as a “duckling” scheme. That is, the client is adopted by the first configuration server that shows proof of integrity. Such a server takes ownership of the “duckling” client.

If the answer to decision block 608 is yes, then the logic proceeds to a block 612 to install the ownership credentials on the client system. In one embodiment, the ownership credentials include a shared secret. Examples of a shared secret include a password, a hash of a password, a random number, or the like.

Continuing to a block 614, the ownership credentials are sealed using the client's TPM. The ownership credentials are the secret that is sealed against a PCR of the client. In one embodiment, the trustworthy server configuration information and the ownership credentials are sealed in the same seal operation to create a single blob. Proceeding to a block 616, the ownership flag of the client is set to true.

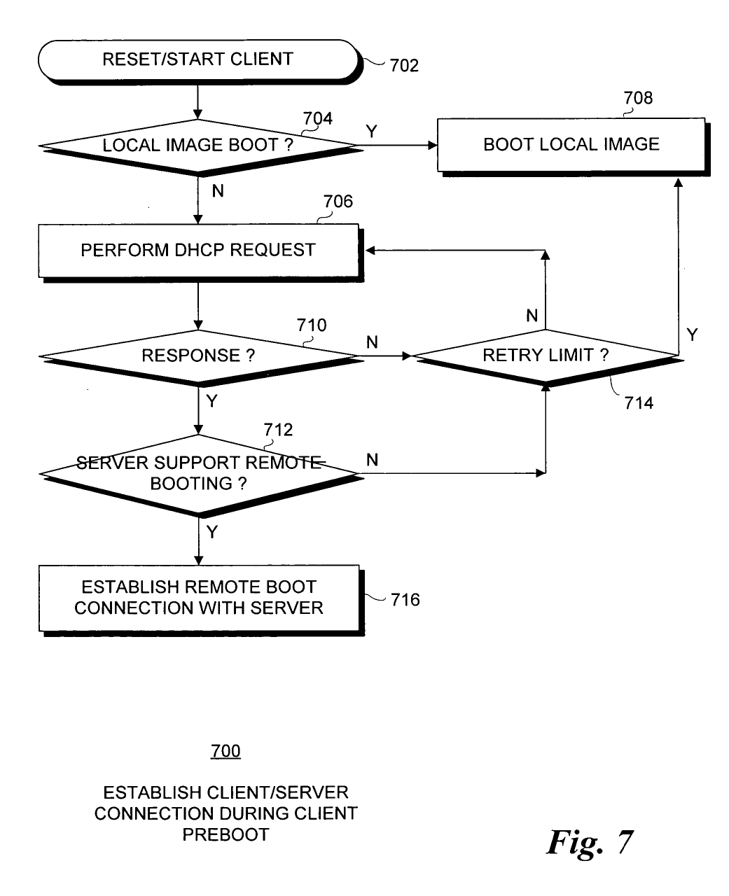

Referring to FIG. 7, a flowchart 700 illustrates the logic and operations to establish a client/server connection during preboot of the client in accordance with one embodiment of the present invention. Starting in a block 702, the client is started/reset. Proceeding to a decision block 704, the logic determines if a local image boot is to be performed on the client. If the answer is yes, then the logic continues to a block 708 to perform a boot of the local image. In one embodiment, the local image includes an OS stored on a hard disk of the client.

If the answer to decision block 704 is no, then the logic proceeds to a block 706 to perform a DHCP request. Proceeding to a decision block 710, the logic determines if a server has responded. If the answer is no, then the logic proceeds to a decision block 714 to determine if the client has reached a predetermined limit to the number tries to find a boot configuration server. If the answer to decision block 714 is no, then the logic proceeds back to block 706. If the answer to decision block 714 is yes, then the logic proceeds to block 708 to perform a local image boot.

If the answer to decision block 710 is yes, then the logic proceeds to a decision block 712 to determine if the responding server supports remote booting. If the answer is no, then the logic proceeds to decision block 714.

If the answer to decision block 712 is yes, then the logic proceeds to a block 716 to establish a remote boot connection with the server. In one embodiment, the client and the server employ PXE.

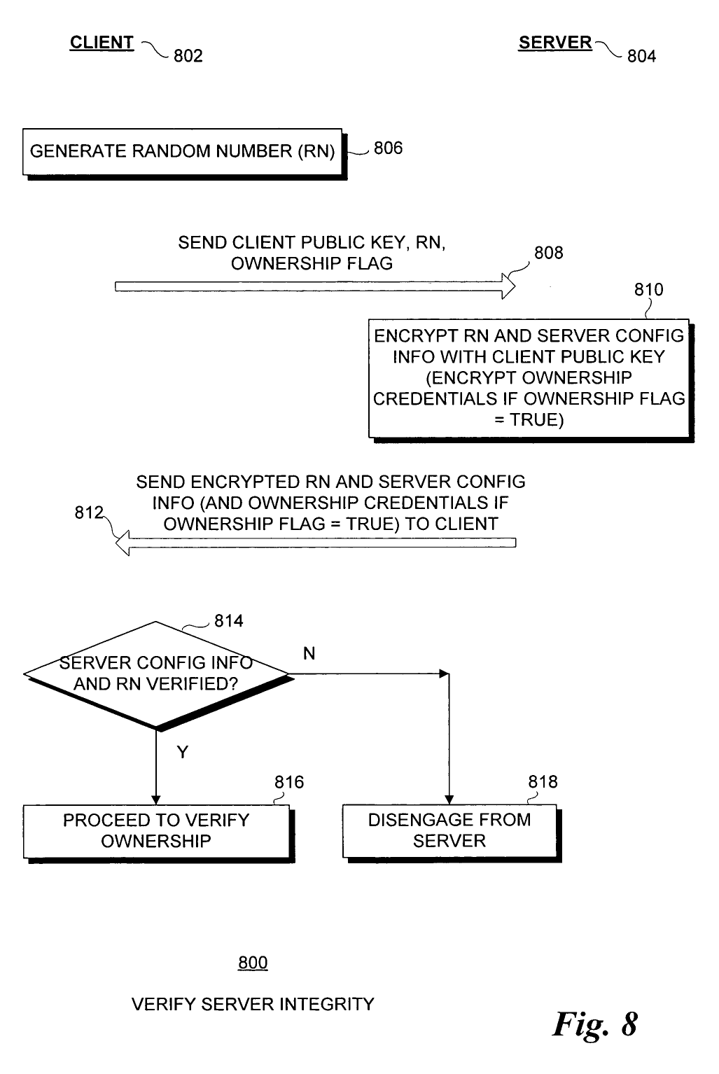

FIG. 8 shows a flowchart 800 illustrating one embodiment of the logic and operations to provide a trustworthy configuration server in accordance with the teachings of the present invention. Flowchart 800 shows one embodiment of verifying the integrity of a server 804 by a client 802.

Starting in a block 806, the client's TPM generates a random number (RN). Proceeding to flow 808, the client sends the client's TPM public key, the RN, and the ownership flag to the server 804. In one embodiment, the client may not generate and send a RN, but only send the public key and ownership flag to server 804.

In a block 810, the server encrypts the RN and the server configuration information using the client's public key. In one embodiment, the server encrypts using functionality available on the server's TPM. In another embodiment, the server uses software to encrypt the client's public key.

In one embodiment, the server configuration information includes a PCR list of server 804. If the ownership flag received from the client is true, then the server will also encrypt the ownership credentials associated with the client.

Continuing to flow 812, server 804 sends the encrypted RN and encrypted server configuration information to client 802. Server 804 may also send encrypted ownership credentials if the ownership flag of the client was set to true.

Proceeding to a decision block 814, client 802 determines if the server configuration information is verified. Client 802 may also verify the RN if an RN was sent to server 804 in flow 808.

Client 802 decrypts the RN and server configuration information received from server 804 using the client's TPM private key. Client 802 compares the server configuration information received from server 804 to the trustworthy server configuration information originally sealed on the client. If the server configurations match, then client 802 knows server 804 is in a trusted configuration. In one embodiment, client 802 unseals the originally sealed trustworthy server configuration information before the comparison is done.

If client 802 receives back the same RN from server 804 that client 802 originally sent, then the client knows the client/server communication is current. Sending an RN and verifying the received RN may defeat a replay attack. In a replay attack, an attacker may catch a network stream from an earlier communication and replay the network stream to the client to spoof the client. The RN confirms the “freshness” of the current session for the client.

If the answer to decision block 814 is yes, then the logic proceeds to a block 816 to proceed to determining if the server has ownership of the client.

If the answer to decision block 814 is no, then the logic proceeds to a block 818 to disengage from server 804. In this case, client 802 cannot trust server 804. Thus, client 802 disconnects from server 804 to prevent malicious actions from being taken on client 802. In one embodiment, client 802 may attempt to connect to another server.

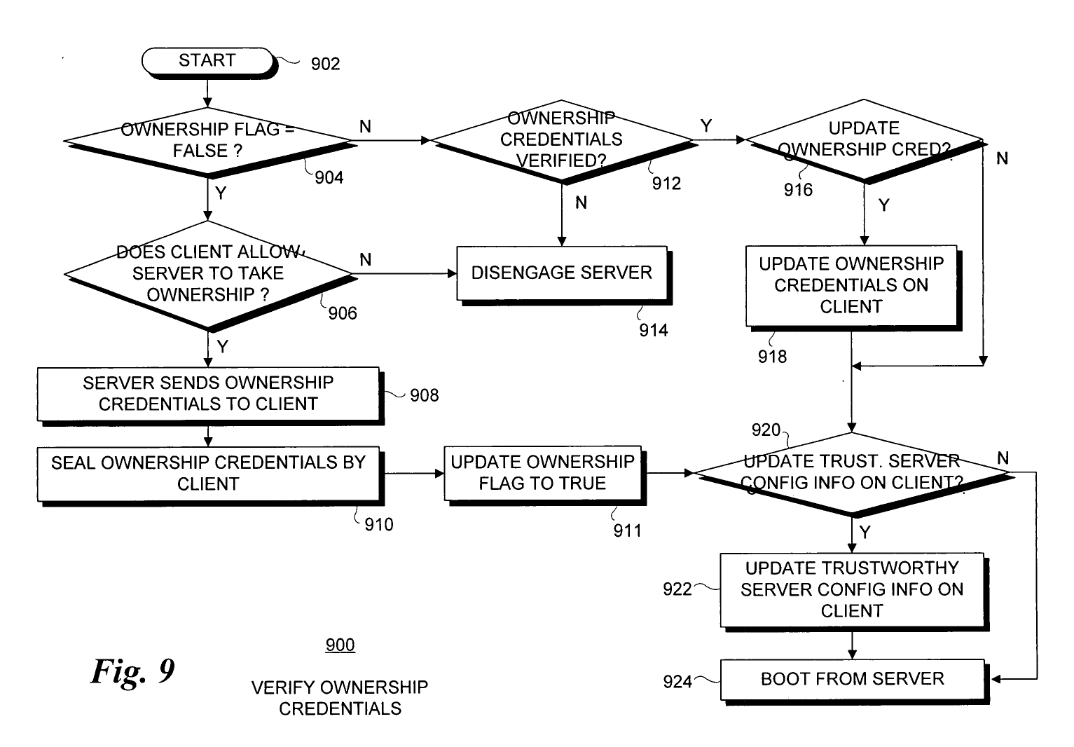

FIG. 9 is a flowchart 900 illustrating one embodiment of the logic and operations to provide a trustworthy configuration server in accordance with the teachings of the present invention. Flowchart 900 shows one embodiment of verifying if a server has ownership of a client. Showing proof of ownership by the server is another layer of security for the client. Also, the proof of ownership provides the server with confidence that the server is sending a boot image file to a client authorized to receive the file. For example, corporations want to ensure boot image files are managed properly. In another example, site licenses may limit the number of OS images a corporation may distribute.

Flowchart 900 begins at start block 902. In decision block 904, the logic determines if the ownership flag of the client is false. If the answer is yes, then the logic proceeds to a decision block 906. In decision block 906, the logic determines if the client allows a server to take ownership. If the answer is no, then the logic proceeds to a block 914 to disengage the client from the server.

If the answer to decision block 906 is yes, then the logic proceeds to a block 908 where the server sends ownership credentials to the client. In one embodiment, the server encrypts the ownership credentials using the client's public key that was received in flow 808 of FIG. 8.

Continuing to a block 910, the ownership credentials are sealed by the client's TPM. Proceeding to a block 911, the ownership flag of the client is updated to true. The logic then proceeds to a decision block 920 (discussed below).

If the answer to decision block 904 is no, then the logic proceeds to a decision block 912. In decision block 912, the logic determines if the ownership credentials have been verified. In one embodiment, the client's TPM determines if the ownership credentials received from the server match the ownership credentials originally sealed on the client. In one embodiment, the client unseals the ownership credentials originally sealed on the client to perform the comparison with the ownership credentials received from the server. If the answer to decision block 912 is no, then the logic proceeds to block 914 to disengage the server. In one embodiment, the client may attempt to connect to another server.

If the answer to decision block 912 is yes, then the logic continues to a decision block 916 to determine if the ownership credentials of the client are to be updated.

If the answer to decision block 916 is no, then the logic continues to decision block 920 (discussed below).

If the answer to decision block 916 is yes, then the logic continues to a block 918 to update the ownership credentials on the client. In one embodiment, the updated ownership credentials are sent to the client from the server. The updated ownership credentials may be encrypted by the server using the client's public key. Once the client receives the encrypted updated ownership credentials, the client decrypts the updated ownership credentials using the client's TPM private key. The client's current ownership credentials may be unsealed and updated with the updated ownership credentials. Then, the ownership credentials are re-sealed by the client's TPM. The logic then continues to decision block 920.

In one embodiment, the client may be shipped from the factory with the manufacturer having ownership. The client may also be shipped as a bare system without an operating system. Once delivered to the customer, the client connects to the manufacturer's server and verifies the server's integrity and ownership. The manufacturer's server then loads an OS onto the client. The ownership credentials are then updated from the manufacturer to the customer who purchased the client.

Continuing in FIG. 9, in decision block 920, the logic determines if the server configuration information on the client is to be updated. If the answer is no, then the logic continues to a block 924 to boot the client from the server. In one embodiment, a boot image file is loaded onto the client from the server and executed.

If the answer to decision block 920 is yes, then the logic continues to a block 922. In block 922, the trustworthy server configuration information stored on the client is updated. In one embodiment, updated server configuration information is sent to the client from the server. This updated server configuration information is encrypted using the client's public key. The client decrypts the updated server configuration information when received. The current trustworthy server configuration information stored on the client is unsealed by the client's TPM, updated with the updated server configuration information, and then sealed again by the client's TPM. After block 922, the logic continues to block 924 to boot the client from the server.

Embodiments of the invention provide a trustworthy configuration server where the client challenges the server. In one embodiment, the client verifies the integrity of the server. In another embodiment, the client verifies whether the server owns the client.

In one embodiment, a system is initialized at a factory or a corporate home base, such as in the embodiment of FIG. 6. The trustworthy server configuration information and ownership credentials are securely stored on the client. In one embodiment, the client's TPM is used to seal the trustworthy server configuration information and ownership credentials.

Continuing with this embodiment, the client is sent to a remote location. The client may have a bare system with no OS. The client is sent bare so that when the client gets to the remote site, the client may receive the latest OS or an OS tailored for the remote site.

At the remote site, the client connects to a server during the client's preboot, such as described in the embodiment of FIG. 7. This connection may be across the Internet between the client and the server. The client proceeds to verify server integrity and to verify ownership. If the server integrity and ownership credentials are good, the OS is then loaded onto the client. Embodiments herein allow the client to ensure the server may be trusted.

FIG. 10 is an illustration of one embodiment of an example computer system 1000 on which embodiments of the present invention may be implemented. Computer system 1000 includes a processor 1002 and a memory 1004 coupled to a chipset 1006. Storage 1012, non-volatile storage (NVS) 1005, network interface (I/F) 1014, and Input/Output (I/O) device 1018 may also be coupled to chipset 1006. Embodiments of computer system 1000 include, but are not limited to a desktop computer, a notebook computer, or the like.

Processor 1002 may include, but is not limited to, an Intel Corporation processor, or the like. In one embodiment, computer system 1000 may include multiple processors. Memory 1004 may include, but is not limited to, Dynamic Random Access Memory (DRAM), Static Random Access Memory (SRAM), Synchronized Dynamic Random Access Memory (SDRAM), Rambus Dynamic Random Access Memory (RDRAM), or the like.

Chipset 1006 may include a Memory Controller Hub (MCH), an Input/Output Controller Hub (ICH), or the like. Chipset 1006 may also include system clock support, power management support, audio support, graphics support, or the like. In one embodiment, chipset 1006 is coupled to a board that includes sockets for processor 1002 and memory 1004.

Components of computer system 1000 may be connected by various buses including a Peripheral Component Interconnect (PCI) bus, a System Management bus (SMBUS), a Low Pin Count (LPC) bus, a Serial Peripheral Interface (SPI) bus, an Accelerated Graphics Port (AGP) interface, or the like. I/O device 1018 may include a keyboard, a mouse, a display, a printer, a scanner, or the like.

The computer system 1000 may interface to external systems through the network I/F 1014. Network I/F 1014 may include, but is not limited to, a modem, a network interface card (NIC), or other interfaces for coupling a computer system to other computer systems. A carrier wave signal 1023 is received/transmitted by network interface 1014. In the embodiment illustrated in FIG. 10, carrier wave signal 1023 is used to interface computer system 1000 with a network 1024, such as a local area network (LAN), a wide area network (WAN), the Internet, or any combination thereof. In one embodiment, network 1024 is further coupled to a remote computer 1025 such that computer system 1000 and remote computer 1025 may communicate over network 1024. Remote computer 1025 may include a TPM 1050.

The computer system 1000 also includes non-volatile storage 1005 on which firmware and/or data may be stored. Non-volatile storage devices include, but are not limited to, Read-Only Memory (ROM), Flash memory, Erasable Programmable Read Only Memory (EPROM), Electronically Erasable Programmable Read Only Memory (EEPROM), Non-Volatile Random Access Memory (NVRAM), or the like. Storage 1012 includes, but is not limited to, a magnetic hard disk, a magnetic tape, an optical disk, or the like. It is appreciated that instructions executable by processor 1002 may reside in storage 1012, memory 1004, non-volatile storage 1005, or may be transmitted or received via network interface 1014.

For the purposes of the specification, a machine-accessible medium includes any mechanism that provides (i.e., stores and/or transmits) information in a form readable or accessible by a machine (e.g., a computer, network device, personal digital assistant, manufacturing tool, any device with a set of one or more processors, etc.). For example, a machine-accessible medium includes, but is not limited to, recordable/non-recordable media (e.g., read only memory (ROM), random access memory (RAM), magnetic disk storage media, optical storage media, a flash memory device, etc.). In addition, a machine-accessible medium may include propagated signals such as electrical, optical, acoustical or other forms of propagated signals (e.g., carrier waves, infrared signals, digital signals, etc.).

It will be appreciated that in one embodiment, computer system 1000 may execute operating system (OS) software. For example, one embodiment of the present invention utilizes Microsoft Windows® as the operating system for computer system 1000. Other operating systems that may also be used with computer system 1000 include, but are not limited to, the Apple Macintosh operating system, the Linux operating system, the Unix operating system, or the like.

The above description of illustrated embodiments of the invention, including what is described in the Abstract, is not intended to be exhaustive or to limit the embodiments to the precise forms disclosed. While specific embodiments of, and examples for, the invention are described herein for illustrative purposes, various equivalent modifications are possible, as those skilled in the relevant art will recognize. These modifications can be made to embodiments of the invention in light of the above detailed description.

The terms used in the following claims should not be construed to limit the invention to the specific embodiments disclosed in the specification. Rather, the following claims are to be construed in accordance with established doctrines of claim interpretation.

What is claimed is:

1. A method, comprising:
establishing a connection between a server and a client during a preboot of the client;
verifying server integrity of the server by the client during the preboot of the client;
booting the client with a boot image file received from the server if the server integrity is verified; and
disengaging from server if the server integrity is not verified.

2. The method of claim 1 wherein verifying server integrity comprises:
sending a client public key to the server;
receiving an encrypted server configuration information from the server, wherein the encrypted server configuration information includes server configuration information encrypted with the client public key;
decrypting the encrypted server configuration information; and
verifying the received server configuration information against trustworthy server configuration information at the client.

3. The method of claim 2, further comprising:
generating a random number at the client;
sending the random number to the server;
receiving an encrypted random number from the server, wherein the encrypted random number includes the random number encrypted with the client public key;
decrypting the encrypted random number; and
verifying that the received random number is the same as the sent random number.

4. The method of claim 1, further comprising:
verifying if the client is owned by the server; and
booting the client with the boot image file if the client is owned by the server and if the server integrity is verified.

5. The method of claim 4 wherein verifying if the client is owned by the server comprises:
sending a client public key to the server;
receiving encrypted ownership credentials from the server, wherein the encrypted ownership credentials includes ownership credentials stored on the server associated with the client encrypted with the client public key;
decrypting the encrypted ownership credentials; and
verifying the received ownership credentials against ownership credentials at the client.

6. The method of claim 4, further comprising:
receiving ownership credentials from the server if the client is not owned and if the client permits the server to take ownership; and
sealing the ownership credentials using a client Trusted Platform Module (TPM).

7. The method of claim 4, further comprising updating ownership credentials of the client, wherein updating ownership credentials comprises:
receiving updated ownership credentials from the server;
unsealing ownership credentials at the client using a client Trusted Platform Module (TPM);
updating the ownership credentials at the client; and
sealing the updated ownership credentials at the client using the client TPM.

8. The method of claim 1, further comprising updating server configuration information at the client with updated server configuration information received from the server.

9. The method of claim 1, further comprising performing a client setup comprising:
sealing trustworthy server configuration information using a client Trusted Platform Module (TPM); and
sealing ownership credentials using a client TPM.

10. The method of claim 1 wherein the client includes a service microcontroller to provide a protected environment of the client for verifying server integrity.

11. The method of claim 1 wherein the client includes a LaGrande Technology compatible processor and a LaGrande Technology compatible chipset to provide a protected environment of the client for verifying server integrity.

12. An article of manufacture comprising:
a machine-accessible medium including a plurality of instructions which when executed perform operations comprising:
establishing a connection with a server by a client during a preboot of the client;
verifying server integrity of the server by the client during the preboot of the client;
verifying ownership credentials of the server associated with the client during the preboot of the client; and
booting the client with a boot image file received from the server if the server integrity is verified and if the ownership credentials are verified.

13. The article of manufacture of claim 12 wherein verifying server integrity comprises:
sending a client Trusted Platform Module (TPM) public key to the server;
receiving encrypted server configuration information from the server, wherein the encrypted server configuration information includes server configuration information encrypted with the client TPM public key;
decrypting the encrypted server configuration information using a client TPM private key; and
verifying the received server configuration information against trustworthy server configuration information at the client.

14. The article of manufacture of claim 13 wherein verifying ownership credentials comprises:
receiving encrypted ownership credentials from the server, wherein the encrypted ownership credentials include ownership credentials stored on the server associated with the client encrypted with the client TPM public key;
decrypting the encrypted ownership credentials using the client TPM private key; and
verifying the received ownership credentials against ownership credentials at the client.

15. The article of manufacture of claim 12 wherein execution of the plurality of instructions further perform operations comprising:
sealing trustworthy server configuration information by a client Trusted Platform Module (TPM); and
sealing ownership credentials by the client TPM.

16. The article of manufacture of claim 12 wherein the plurality of instructions are to be executed in a protected environment of the client.

17. A method, comprising:
establishing a connection between a client and a server;
receiving a request for proof of server integrity at the server from the client; and
sending proof of server integrity to the client from the server.

18. The method of claim 17 wherein receiving the request for proof of server integrity comprises:
receiving a client Trusted Platform Module (TPM) public key from the client at the server;
encrypting server configuration information with the client TPM public key, wherein the encrypted server configuration information serves at least in part as proof of server integrity;
sending the encrypted server configuration information to the client.

19. The method of claim 18 wherein receiving the request for proof of server integrity comprises:
receiving a random number from the client at the server;
encrypting the random number with the client TPM public key, wherein the encrypted random number serves at least in part as proof of server integrity; and
sending the encrypted random number to the client.

20. The method of claim 18, further comprising sending updated server configuration information to the client from the server.

21. The method of claim 18, further comprising:
receiving a request for proof of ownership at the server from the client;
encrypting ownership credentials stored on the server that are associated with the client using the client TPM public key; and
sending the encrypted ownership credentials to the client.

22. The method of claim 21, further comprising sending updated ownership credentials to the client from the server.

23. The method of claim 21 wherein the server includes a TPM to encrypt the server configuration information and to encrypt the ownership credentials.

24. A client system, comprising:
a processor;
a Trusted Platform Module (TPM) coupled to the processor; and
a machine-accessible medium coupled to the processor, the machine-accessible medium including a plurality of instructions which when executed by the processor perform operations comprising:
establishing a connection with a server by the client system during a preboot of the client system;
verifying server integrity of the server by the client system during the preboot of the client system;
verifying ownership credentials of the server associated with the client system during the preboot of the client system; and
booting the client system with a boot image file received from the server if the server integrity is verified and if the ownership credentials are verified.

25. The client system of claim 24, wherein the processor is part of a service microcontroller of the client system, the service microcontroller to provide a protected environment for execution of the plurality of instructions.

26. The client system of claim 24, further comprising a Lagrande Technology chipset coupled to the processor, wherein the processor includes a Lagrande Technology central processing unit.

27. The client system of claim 24 wherein verifying server integrity comprises:
sending a client TPM public key to the server;
receiving encrypted server configuration information from the server, wherein the encrypted server configuration information includes server configuration information encrypted with the client TPM public key;
decrypting the encrypted server configuration information using a client TPM private key; and
verifying the received server configuration information against trustworthy server configuration information at the client system.

28. The client system of claim 27 wherein verifying ownership credentials comprises:
receiving encrypted ownership credentials from the server, wherein the encrypted ownership credentials include ownership credentials stored on the server associated with the client system encrypted with the client TPM public key;
decrypting the encrypted ownership credentials using the client TPM private key; and
verifying the received ownership credentials against ownership credentials at the client system.
